(19) United States
(12) Patent Application Publication
(10) Pub. No.: US 2010/0091364 A1
(43) Pub. Date: Apr. 15, 2010

(54) Apparatus and method of conveying constituents

(75) Inventor: Alan L. Wozniak, Clearwater, FL (US)

Correspondence Address: David A. Frijouf, 201 East Davis Boulevard, Tampa, FL, 33606, US

(73) Assignee: Pure Air Control Services, Inc., Clearwater, FL (US)

(21) Appl. No.: 12/583,444

(22) Filed: Aug. 19, 2009

Related U.S. Application Data
(63) Continuation of application No. 11/326,144, filed on Jan. 4, 2006, now abandoned.
(60) Provisional application No. 60/641,186, filed on Jan. 4, 2005.

(51) Int. Cl. G02B 21/34

(52) U.S. Cl. 359/397

(57) ABSTRACT

An apparatus is disclosed for conveying microscopic constituents from a testing surface to a slide. The microscopic constituents are observed through a viewer. A transparent tape permits the passage of light through the transparent tape. A plurality of markers are positioned on the transparent tape. An adhesive layer on the transparent tape affixes the constituents about the plurality of markers upon impressing the transparent tape against the testing surface. The adhesive layer affixes the transparent tape to the slide for preserving and restraining the constituents. The transparent tape and the slide enable the identification and calculation of the number of the constituents per each area occupied by each of the plurality of markers.

### BACKGROUND OF THE INVENTION

1. Field of the Invention

This invention relates to conveying constituents and more particularly to an improved apparatus for conveying microscopic constituents from a testing surface to a slide for viewing the microscopic constituents through a viewer.

2. Background of the Invention

Various types of apparatuses and processes have been proposed by the prior art for viewing microscopic constituents through a viewer. Viewing microscopic constituents through a viewer may reveal beneficial information including the number and differing types of microscopic constituents within a test area. Many human illnesses are directly related to the number and type of microscopic constituents present in their environment. In addition, many types of manufacturing processes require the environment to be void of high concentrations of microscopic constituents. As such, regular testing of areas could potentially save hundreds of thousands of people and millions of dollars per year.

In the past, the majority of apparatuses and/or processes for viewing microscopic constituents were labor intensive and required sophisticated equipment. As a result, such analysis was costly and limited the number of individuals and companies who could justify such a service.

In addition, transporting the microscopic constituents from the testing area to the viewer was problematic. Contamination was highly probable either during the collection of the microscopic constituents, during the transportation of the microscopic constituents or during the viewing of the microscopic constituents through the viewer. The following U.S. patents are examples of attempt of the prior art to solve these problems.

U.S. Pat. No. 1,214,331 to M. Levy discloses a haemocytometer having its counting chamber positioned below the face of the slide, for use with a cover-plate that is supported by the slide to bridge the counting chamber.

U.S. Pat. No. 1,313,962 to F. G. Spindler discloses a haemacytometer comprising a slide of uniform thickness having a scale slip mounted thereon and projecting slightly above the level of the top surface of the slide, two cover plate supports, integral with said slide and parallel with said scale slip and projecting materially above the level of the top surface of said scale slip.

U.S. Pat. No. 1,630,146 to S. Trenner discloses a haemacytometer counting chamber including a ruled area, a clearly defined and immediately distinguishable surface for focusing, and distinctive guide means extending from said surface in the direction of said ruling.

U.S. Pat. No. 1,647,865 to C. A. Hausser discloses a defining line for haemacytometers and like microscope slides consisting of the transparent line between two closely adjacent parallel opaque lines.

U.S. Pat. No. 1,824,097 to H. G. Ott discloses a microscope slide of the counting chamber type formed of glass having an index of refraction in excess of 1.57, with rulings upon a surface thereof.

U.S. Pat. No. 2,235,310 to W. Bausch discloses a hemacytometer comprising a light-transmitting plate having an opening, a light-transmitting member secured in said opening, said member having a ruled area on an exposed surface which is substantially coextensive with said surface, said member and plate having a different light transmittance whereby said ruled area may be easily located under a microscope.

U.S. Pat. No. 2,328,585 to J. T. Rooney discloses a microscopic slide or the like comprising a body portion of transparent material of a given controlled color having upon a portion of a face thereof a coating of inherently transparent material of a controlled color different from that of the body portion and having a plurality of subdivided areas along lines resulting from the effective removal of at least a portion of the material of the coating along said lines, said areas being of a transparent color resulting from light transmitted through the combined colors of said materials with the lines being predominately of the color of the material of the body portion.

U.S. Pat. No. 3,436,140 to T. J. Lord discloses a holder having the character of a microscope slide adapted to receive a filter patch for particulate counting in which the patch is protected from atmospheric contamination and other introduced error while exposing the patch for full surface, low tolerance counting.

U.S. Pat. No. 3,829,216 to M. D. Persidsky discloses an optical apparatus and method for counting sperm cells in a shallow chamber under a microscope. The chamber is formed in a microscope slide and covered by a cover slip provided with reference lines to facilitate counting of the cells.

U.S. Pat. No. 4,190,314 to S. Goldsmith discloses a microscope slide for cytological analysis of the type where it is extremely important that the presence of a small number of cancer cells present in a smear be detected. A plurality of spaced parallel lines are permanently placed on the slide with the space between each successive pair of lines defining a reference plane. The spacing between each pair of lines corresponds to the field of view produced by the particular microscope lens and eyepiece being utilized so that when a viewer makes a viewing pass across each successive reference plane that the smear is located in, by keeping the lines continuously in the field of view during each pass, the entire area of the smear will be viewed.

U.S. Pat. No. 4,556,297 to F. C. Schulz, Jr. discloses an optical counting device of the type used for counting mineral particles suspended within a liquid, for example, ore float tailings. The counting device includes a plate imprinted with a gridiron in its mid-portion, an absorbent doughnut pad removably supported upon the plate and conformed such that the gridiron on the plate is in register with the open space of the doughnut pad and a doughnut housing having an open space at its mid-portion defining a counting chamber in register with the gridiron and open space of the absorbent pad. The counting chamber facilitates a random distribution of suspended particles over the gridiron, while the suspending medium is withdrawn into the absorbent pad.

U.S. Pat. No. 4,568,148 to R. A. Onanian discloses a hand-held collapsible microscope system having a lens section for holding a lens and a stage section for holding a specimen to be viewed. A lens in the lens section and a stage hole in the stage section are aligned with each other when the system is erected, and the stage section holds a specimen in registration with the stage hole. First and second resilient pleated sections interconnect the longitudinal edges of the lens section with the corresponding longitudinal edges of the stage section for enabling the sections to be erected with the lens and stage hole aligned and the distance between them to be adjustable for focussing by gentle finger pressure squeezing the lens section toward the stage section, and for enabling the sections to be swung to the collapsed position with the pleats extended and the sections flat on one another. A blank for making the microscope system is also disclosed.

U.S. Pat. No. 4,812,029 to R. A. Onanian discloses a microscope system which includes an eyepiece section and a base having an integral stage section for holding a specimen to be viewed. The eyepiece section holds a lens and further includes integral bearing elements for movably engaging a complementary guide in the base. A stage hole in the stage section is aligned with the lens and a specimen is held in registration with the stage hole. An adjustment mechanism is provided to finely adjust the position of the eyepiece relative to the base to adjust the focus of the lens. Light is gathered and directed to the specimen by an angularly adjustable mirror or an optical wave guide.

U.S. Pat. No. 5,349,436 to H. Fisch discloses a biological assembly for effecting the examination of a sample in a liquid medium under magnification. The assembly includes a transparent slide with a sample chamber and an immediately adjacent overflow chamber formed on one main surface by a thin film. The sample chamber is receptive of a sample in a liquid medium. The transparent slide, having a pattern for aligning it with the sample chamber, is disposed over the sample chamber. The transparent slide includes a grid etched into the lower surface thereof to enable the counting of cells under magnification.

U.S. Pat. No. 5,764,355 to D. R. Gagnon discloses a device for holding a sample to be spectroscopically analyzed in which the sample is retained within a defined area. The device includes a receiving medium on which the sample is held. When this receiving medium is mounted in a frame (an optional feature), it extends across an aperture in the frame. In/on the receiving medium is a sample confining region that keeps any sample placed on the receiving medium from migrating outside a defined area. By keeping the sample within a defined area, quantitative measurements of the sample can be obtained.

U.S. Pat. No. 5,812,312 to A. E. Lorincz discloses a self-staining microscopic slide designed for immediate staining and viewing of cells in biological fluid and tissue samples, preferably with an epi-fluorescence microscope. The pre-prepared microscope slide preferably has a supravital fluorescent stain applied thereon, which is overlaid with a transparent tape or film. During use, the film is peeled back to expose the stain so that a sample cane be applied thereon for intermixture therewith. The film is then replaced over the stained sample to act as a cover slip for immediate viewing. Living cells and microorganisms are rendered dramatically visible and cellular dysmorphology can be readily ascertained. The time and cost associated with preparing a fixed and sectioned sample is completely avoided as well as the problem of artifacts and sample fragmentation found in fixed preparations. The slide can include reference standards to facilitate microscope focusing, and to allow measurements of cells and microorganisms. An alternate embodiment provides a flexible microscope slide which can be folded over such that a viewing portion of the slide can be placed against a specimen to obtain a sample directly therefrom without the need of transferring devices, thereby reducing biological hazards. This novel slide permits on-site, point-of-care screening in a matter of minutes of any biological fluid or tissue sample for presence of infectious agents.

U.S. Pat. No. 6,567,214 to A. E. Lorincz discloses a microscope slide having a well formed therein, wherein the well is filled with culture media. The slide is designed for on-site collection, staining, and viewing of cells in biological fluid and tissue samples, preferably with an epi-fluorescence microscope. This novel slide permits point-of-care screening in a matter of minutes of any biological fluid or tissue sample for presence of infectious agents, after which, the slide can be transported to a central lab for culture and/or definitive identification.

U.S. Pat. No. 6,597,500 to J. Burke et al. discloses an adhesive label for attaching to a microscope slide. The label may have one or more grids or arrays provided on it to help an operator to manually spot a microscope slide.

Although the aforementioned prior art have contributed to the development of the art of conveying microscopic constituents from a testing surface to a slide for viewing the microscopic constituents through a viewer, none of these prior art patents have solved the needs of this art.

Therefore, it is an object of the present invention to provide an improved apparatus for viewing the microscopic constituents through a viewer.

Another object of this invention is to provide an improved apparatus for conveying microscopic constituents from a testing surface to a slide for viewing the microscopic constituents through a viewer.

Another object of this invention is to provide an improved apparatus that will reduce the potential of contamination of constituents during the collection, transportation and/or viewing of the microscopic constituents.

Another object of this invention is to provide an improved apparatus that will reduce the labor and equipment required to collect, transport and/or view the microscopic constituents.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention relates to an improved method and apparatus for conveying microscopic constituents from a testing surface to a slide. The slide is placed on a viewer for viewing the microscopic constituents. The apparatus comprises a transparent tape for permitting the passage of light through the transparent tape. The transparent tape includes a plurality of markers and an adhesive layer for affixing the constituents about the plurality of markers upon impressing the transparent tape against the testing surface. The adhesive layer is then used to affix the transparent tape to the slide for preserving and restraining the constituents. The transparent tape and the slide enable the identification and calculation of the number of the constituents per each area occupied by each of the plurality of markers.

In a more specific embodiment of the invention, the slide comprises a microscope slide and the viewer includes a microscope.

In one example of the invention, the plurality of markers comprises a grid printed on the transparent tape. The grid includes a plurality of parallel lines and a plurality of parallel transverse lines for creating a plurality of areas with equivalent dimensions. The plurality of parallel lines and a plurality of parallel transverse lines include a colored pigment or a fluorescent colored pigment.

In another example of the invention, the transparent tape includes a label area for recording information.

The invention is also incorporated into the method of collecting and viewing microscopic constituents through a microscope. The method comprising the steps of first impressing an adhesive tape having a plurality of markers to a test surface for affixing the constituents to the adhesive tape, second impressing the adhesive tape to a microscope slide for preserving and restraining movement of the constituents; and third placing the adhesive tape and the microscope slide under the microscope to identify and count the number of the constituents per each area occupied by each of the plurality of markers. The step of counting the number of the constituents includes establishing the total number of constituents observed per the total area observed under the microscope.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is a front isometric view of a transparent tape of the present invention;

FIG. 2 is a front isometric view similar to FIG. 1 illustrating the transparent tape being separated from a liner;

FIG. 3 is a front isometric view similar to FIG. 1 illustrating the transparent tape being impressed upon a testing surface;

FIG. 4 is a front isometric view of a microscope slide;

FIG. 5 is a front isometric view of the transparent tape affixed to the microscope slide;

FIG. 6 is a front isometric view of the transparent tape and microscope slide inserted within a microscope; and

FIG. 7 is a top magnified view of a portion of the transparent tape and microscope slide.

Similar reference characters refer to similar parts throughout the several Figures of the drawings.

### DETAILED DISCUSSION

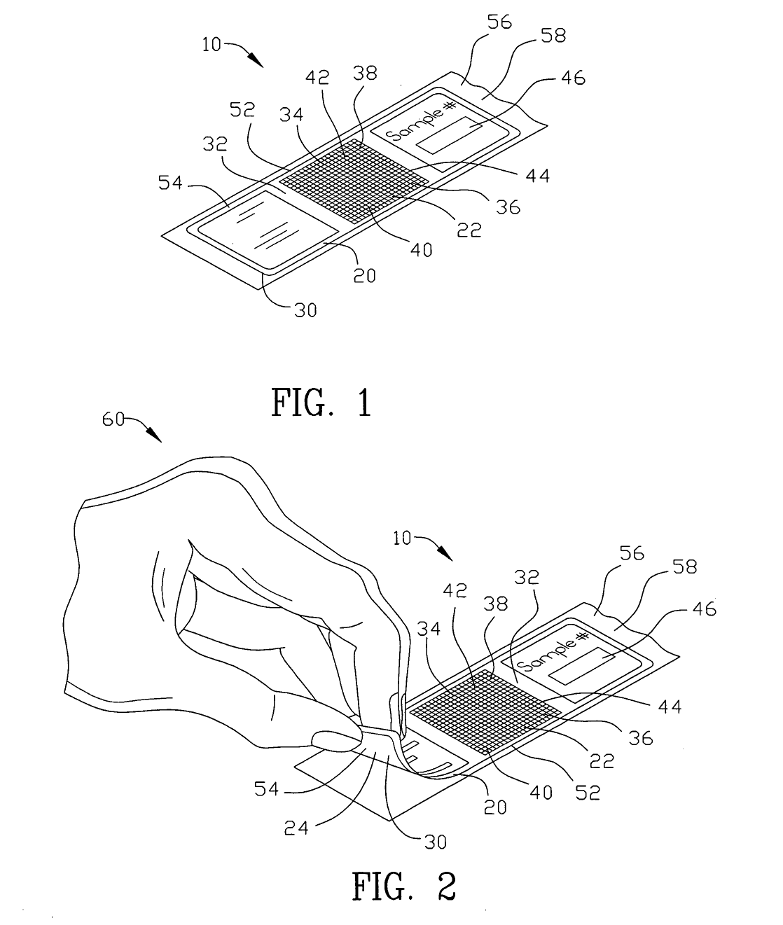

FIG. 1 is a FIGS. 1 thru 5 are front isometric views of an apparatus 10 for conveying microscopic constituents 12 from a testing surface 14 to a slide 16. The slide 16 is then placed on a viewer 18 for observing the qualitative and/or quantitative characteristics of the microscopic constituents 12. The microscopic constituents 12 may include viable and non-viable particulate, namely, fungus/fungal spores, pollen, insect parts, mites, skin cell fragments, fibers (manmade, fiber glass, plant trichomes etc.) and other organic and inorganic particles. The testing surface 14 may include any surface which may withstand impaction from the apparatus 10. The slide 16 may include a microscope slide 26 or other rigid or semi-rigid material which will retain the apparatus 10 in a horizontal plane.

The apparatus 10 comprises a transparent tape 20 having a bottom receiving surface 30 and a top receiving surface 32. The transparent tape 20 may be constructed of a clear plastic. The transparent tape 20 may also be constructed of polyester material including a clear mylar with a thermal transfer receptive top coating having a thickness within the range of one (1) to three (3) mil thickness wherein a mil is a unit of length equal to 0.001 inch.

The top receiving surface 32 includes a plurality of markers 22 for dividing the top receiving surface 32 into a plurality of areas 40. The plurality of markers 22 comprise a grid 34 printed on the transparent tape 20. The grid 34 includes a plurality of parallel lines 36 and a plurality of parallel transverse lines 38 for creating a plurality of areas 40. The number of plurality of parallel lines 36 and the plurality of parallel transverse lines 38 printed on the transparent tape 20 may both equal twenty-one (21) such that the grid 34 is subdivided into 20 divisions. The distance between each of the plurality of parallel lines 36 and the plurality of parallel transverse lines 38 may be within the range of one (1) to four (4) centimeters. For example, if the distance between each of the plurality of parallel lines 36 and the plurality of parallel transverse lines 38 is two (2) centimeters, the plurality of areas 40 would equal two (2) cm2.

The composition of the plurality of parallel lines 36 and a plurality of parallel transverse lines 38 may include an ink, die or toner. The plurality of parallel lines 36 and a plurality of parallel transverse lines 38 may also include a water-based ink applied to the transparent tape by a flexographic printing press. The plurality of parallel lines 36 and the plurality of parallel transverse lines 38 may also include a colored pigment 42. The plurality of parallel lines 36 and the plurality of parallel transverse lines 38 may include a fluorescent colored pigment 44.

The bottom receiving surface 30 includes a collection area 52 for impressing against the testing surface 14. The bottom receiving surface 30 also includes a locking area 54 for impressing against the microscope slide 26. The bottom receiving surface 30 also includes an adhesive layer 24 for securing the constituents within the collection 52 and securing said locking area 54 against the microscope slide. The plurality of markers 22 are positioned above the collection area 52 for simultaneously viewing the plurality of markers 22 and the collection area 52.

The adhesive layer 24 may include cyanoacrylate adhesives. The adhesive layer 24 may also include an acrylic based permanent adhesive having a thickness within the range of one-half (0.5) and two (2) mil. The acrylic based permanent adhesive may be applied to the bottom receiving surface 30 by flooding the acrylic adhesive in liquid form to the transparent tape 20 with rollers and doctor blades. A liner 56 is then placed over the adhesive layer 24 to prevent the adhesive layer 24 from securing constituents 12 before the transparent tape 20 is removed from the liner 56. The liner 56 may include a liner coating 58 to prevent the adhesive layer 24 from bonding the transparent tape 20 to the liner 56. The liner coating 58 may include a natural wax or synthetic wax.

The transparent tape 20 may also include a label area 46 wherein information regarding the date, location and/or time of collecting the contaminants 12 from the testing surface can be recorded. The information may be hand written using a ballpoint pen or other writing device.

FIGS. 2-7 illustrate the process for utilizing the apparatus 10 for collecting and viewing microscopic constituents 12. Before removing the transparent tape 20 from the liner 56, a user 60 may place information within the label area 46.

FIG. 2 is a front isometric view illustrating the user 60 removing the transparent tape 20 from the liner 56. Once the transparent tape 20 is removed from the liner 56, the transparent tape 20 should be utilized immediately thereafter to avoid contamination from other sources besides the testing surface 14. The user 60 should also use care in retaining the transparent tape 20 folded back with the bottom receiving surface 30 turned outward such that the adhesive layer 24 will not bond the bottom receiving surface 30 together.

FIG. 3 is a front isometric view illustrating the user 60 positioning the transparent tape 20 onto the testing surface 14. The microscopic constituents 12 are conveyed from the testing surface 14 to the transparent tape 20 by impacting the collection area 52 of the bottom receiving surface 30 against the testing surface 14. Once the collection area 52 is in contact with the testing surface 14, a minimal force is applied to the top receiving surface 32. A bland end of a pencil may apply this force against the top receiving surface 32. During impaction the adhesive layer 24 within the collection area 52 adheres the microscopic constituents 12 to the transparent tape 20. The adhesive layer 24 is capable of adhering microscopic constituents 12 of various sizes. The adhesive layer 24 may effectively adhere microscopic constituents 12 ranging from less than one (1) micron to two (2) millimeters without destroying or changing the original properties of the microscopic constituents 12. When the testing surface 14 has a high concentration of microscopic constituents 12, a second transparent tape 20 may be used on the previous testing surface 14 for further conveying the microscopic constituents 12 from the testing surface 14 to the transparent tape 20.

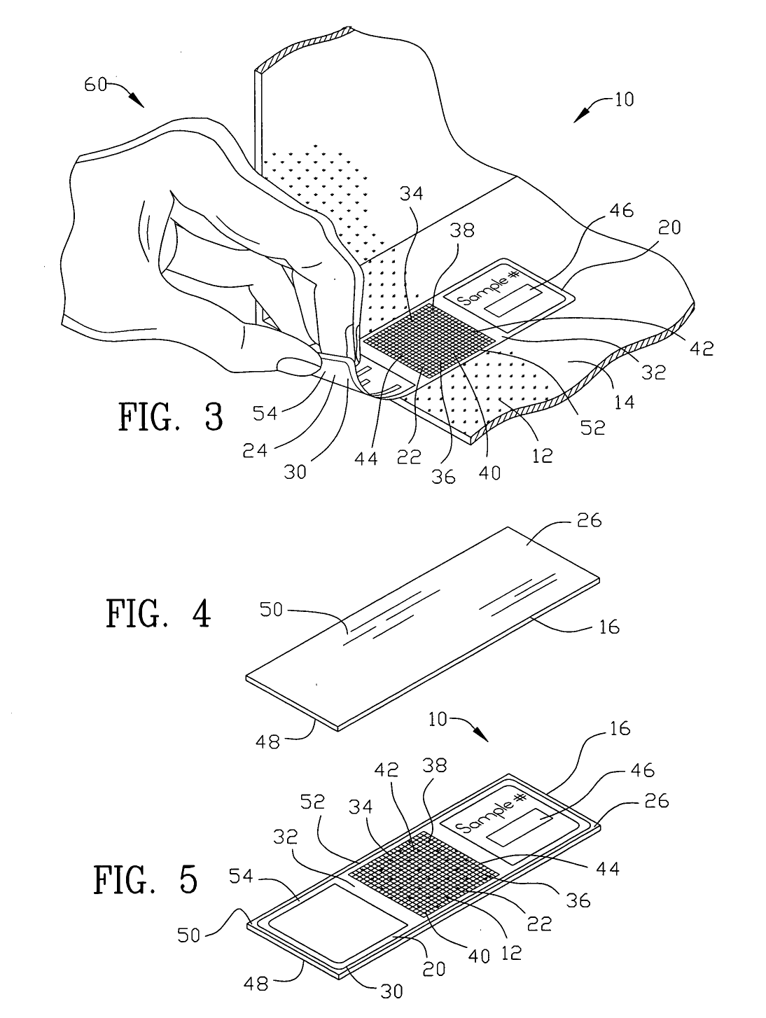

FIG. 4 is a front isometric view of the microscope slide 26. The microscope slide 26 has a bottom engaging surface 48 and a top engaging surface 50. Before mating the microscope slide 26 with the transparent tape 20, the microscope slide 26 should be free of any contaminants and sterilized.

FIG. 5 is a front isometric view of the transparent tape 20 affixed to the microscope slide 26. After the microscopic constituents 12 are conveyed from the testing surface 14 to the transparent tape 20, the transparent tape 20 is then affixed to the microscope slide 26. More specifically, the bottom receiving surface 30 of the transparent tape 20 is applied to the top engaging surface 50 of the microscope slide 26. In doing so, the adhesive layer 24 within the locking area 54 affixes the transparent tape 20 to the microscope slide 26 and preserves and restrains movement of the microscopic constituents 12 within the collection area 52. The adhesive layer 24 within the collection area 52 serves to preserve and restrain movement of the microscopic constituents 12 relative to the grid 34. Once the transparent tape 20 is affixed to the microscope slide 26 by the adhesive layer 24, entry of any further constituents between the transparent tape 20 and the microscope slide 26 are reduced. Preferably, the collection area 52 is positioned approximately midpoint of the microscope slide 26.

After the microscopic constituents 12 are preserved and restrained between the microscope slide 26 and the transparent tape 20, the microscope slide 26/transparent tape 20 combination may be transported to a laboratory using a padded envelop or other shipping envelope.

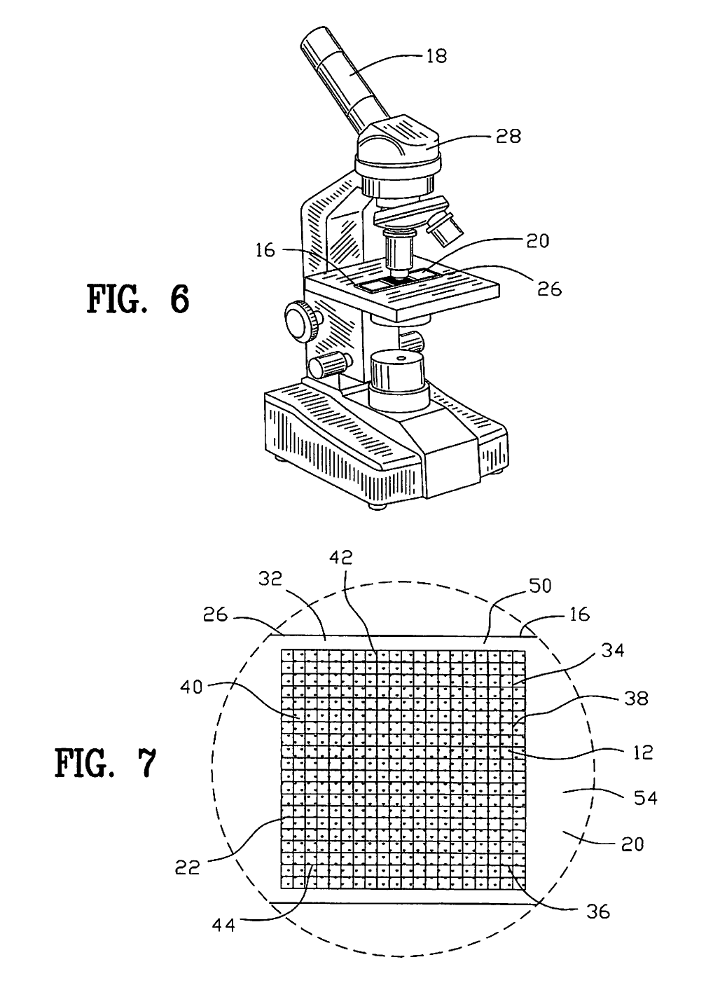

FIG. 6 is a front isometric view of the microscope slide 26 and transparent tape 20 combination inserted into the viewer 18. The viewer 18 may include a microscope 28 with multiple magnifications 62 and a light source 64. The microscope slide 26 and transparent tape 20 combination are placed under the microscope 28 to identify and determine the concentration of the microscopic constituents 12. More specifically, the microscope slide 26 and transparent tape 20 combination is placed under the microscope 28 to identify and count the number of the microscopic constituents 12 per each plurality of areas 40 occupied by each of the plurality of markers 22.

FIG. 7 is a top magnified view of the transparent tape 20 and the microscope slide 26 as viewed through the microscope 28. The user 60 may identify and count of the number of microscopic constituents 12 by reviewing the collection area 52 with the aid of a microscope 28. The collection area 52 containing the microscopic constituents 12 is positioned within the viewing field of the microscope 28. The grid 34 is positioned above the collection area 52 for simultaneously viewing the grid 34 and the microscopic constituents 12.

The user 60 may first view the grid 34 through the microscope 28 under a low magnification (10×10) to determine the uniformity of the microscopic constituents 12. The user 60 may then view the grid 34 through the microscope 28 under a high magnification (10×40 or 10×100) to observe the microscopic constituents 12 in more detail.

To determine the qualitative characteristics of the microscopic constituents 12 the following processes and/or characteristics may be evaluated through a viewer 18 including but not limited to: gross morphology, cytoplasmic matrix, color, shape and size, surface texture, brightness, absorption and reflection of light, internal morphology, and similarity in spore. The actual dimension of the microscopic constituents 12 may be calculated by the use of a stage micrometer.

To determine the quantitative characteristics of the microscopic constituents 12 the number of microscopic constituents 12 and the actual area of transparent tape 20 observed under the microscope 28 are calculated in terms of per centimeters square (cm2).

$$\frac{Number of microscopic constituents}{cm 2} = \frac{\begin{matrix}Total number of \\ microscopic constituents observed\end{matrix}}{\begin{matrix}Total area observed \\ under the mircoscope \end{matrix}} \times 10$$

If a microscopic constituent 12 can not be positively identified the unidentified microscopic constituent 12 should be counted and recorded in an unidentified column with a broad characterization.

The user 60 may only count individual microscopic constituent 12 that are found entirely within an area 40 or if the individual microscopic constituent 12 is crossing a plurality of parallel lines 36 by more than fifty percent (50%). If a microscopic constituent 12 is crossing a plurality of parallel lines 36 by less than fifty percent (50%) the microscopic constituent 12 may not be counted. In addition, if the microscopic constituents 12 have a non-uniform deposition over a plurality of areas 40, the microscopic constituents 12 should not be counted in those areas 40.

If the number of microscopic constituents 12 exceed one hundred (100) in less than five (5) of the plurality of areas 40, the counting should be terminated at the that area 40 and the rule of average should be applied to average of number of microscopic constituents 12 within twenty-five (25) areas 40. For example, if the total number of a particular microscopic constituent 12 equals one hundred twenty (120) in three (3) areas 40, the average for twenty-five (25) areas 40 will equal to one thousand (1000) counts.

$$Average number of microscopic constituents within 25 areas = \frac{Number of constituents}{Number of Areas} \times 25$$

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

1. An apparatus for conveying microscopic constituents from a testing surface to a slide, the microscopic constituents observed through a viewer, comprising:
a transparent tape for permitting the passage of light through said transparent tape;
a plurality of markers on said transparent tape;
an adhesive layer on said transparent tape for affixing the constituents about said plurality of markers upon impressing said transparent tape against the testing surface;
said adhesive layer affixing said transparent tape to the slide for preserving and restraining the constituents;
said transparent tape and the slide enabling the identification and calculation of the number of the constituents per each area occupied by each of said plurality of markers; and
said transparent tape including a label area for enabling information to be written within said label area of said transparent tape regarding the collection of the microscopic constituents from the testing surface.

2. An apparatus for conveying microscopic constituents from a testing surface to a slide as set forth in claim 1, wherein the slide comprises a microscope slide.

3. An apparatus for conveying microscopic constituents from a testing surface to a slide as set forth in claim 1, wherein the viewer comprises a microscope.

4. An apparatus for conveying microscopic constituents from a testing surface to a slide as set forth in claim 1, wherein said transparent tape includes a bottom receiving surface and a top receiving surface;
said bottom receiving surface comprises said adhesive layer for affixing the constituents to said transparent tape; and
said plurality of markers located on said top receiving surface of said transparent tape.

5. An apparatus for conveying microscopic constituents from a testing surface to a slide as set forth in claim 1, wherein said transparent tape includes a bottom receiving surface and a top receiving surface; and
said bottom receiving surface comprises said adhesive layer for affixing said transparent tape to the slide.

6. An apparatus for conveying microscopic constituents from a testing surface to a slide as set forth in claim 1, wherein said plurality of markers comprises a grid printed on said transparent tape.

7. An apparatus for conveying microscopic constituents from a testing surface to a slide as set forth in claim 1, wherein said plurality of markers comprises a grid printed on said transparent tape; and
said grid includes a plurality of parallel lines and a plurality of parallel transverse lines for creating a plurality of areas with equivalent dimensions.

8. An apparatus for conveying microscopic constituents from a testing surface to a slide as set forth in claim 1, wherein said plurality of markers comprises a grid printed on said transparent tape;
said grid includes a plurality of parallel lines and a plurality of parallel transverse lines for creating a plurality of areas with equivalent dimensions; and
said plurality of parallel lines and a plurality of parallel transverse lines include a colored pigment.

9. An apparatus for conveying microscopic constituents from a testing surface to a slide as set forth in claim 1, wherein said plurality of markers comprises a grid printed on said transparent tape;
said grid includes a plurality of parallel lines and a plurality of parallel transverse lines for creating a plurality of areas with equivalent dimensions; and
said plurality of parallel lines and a plurality of parallel transverse lines include a fluorescent colored pigment.

10. (canceled)

11. An apparatus for collecting and viewing microscopic constituents through a microscope, the microscopic constituents taken from a testing surface to assess the microscopic constituents of the testing surface, comprising:
a microscope slide having a bottom engaging surface and a top engaging surface;
a transparent tape having a bottom receiving surface and a top receiving surface;
a collection area on said bottom receiving surface for impressing against the testing surface;
a locking area on said bottom receiving surface for impressing against said top engaging surface of said microscope slide;
an adhesive layer on said bottom receiving surface for securing the constituents within said collection area and securing said locking area against said top engaging surface of said microscope slide;
a plurality of markers on said top receiving surface for dividing said top engaging surface into a plurality of areas;
said plurality of markers of said top receiving surface positioned above said collection area of said bottom receiving surface for simultaneously viewing said plurality of markers and said collection area through the microscope;
said bottom receiving surface of said transparent tape applied to the testing surface for engaging said adhesive layer within said collection area of said bottom receiving surface to collect the constituents;
said bottom receiving surface of said transparent tape applied to the top engaging surface of said microscope slide for engaging said adhesive layer within said locking area for preserving and restraining movement of the constituents; and
said transparent tape and said microscope slide placed under the microscope to identify and determine the concentration of the constituents.

12. An apparatus for collecting and viewing microscopic constituents through a microscope as set forth in claim 11, wherein said plurality of markers comprises a grid printed on said transparent tape.

13. An apparatus for collecting and viewing microscopic constituents through a microscope as set forth in claim 11, wherein said plurality of markers comprises a grid printed on said transparent tape; and
said grid includes a plurality of parallel lines and a plurality of parallel transverse lines for creating a plurality of areas with equivalent dimensions.

14. An apparatus for collecting and viewing microscopic constituents through a microscope as set forth in claim 11, wherein said plurality of markers comprises a grid printed on said transparent tape;
said grid includes a plurality parallel lines and a plurality of parallel transverse lines for creating a plurality of areas with equivalent dimensions; and
said plurality of parallel lines and a plurality of parallel transverse lines include a colored pigment.

15. An apparatus for collecting and viewing microscopic constituents through a microscope as set forth in claim 11, wherein said plurality of markers comprises a grid printed on said transparent tape;
said grid includes a plurality of parallel lines and a plurality of parallel transverse lines for creating a plurality of areas with equivalent dimensions; and
said plurality of parallel lines and a plurality of parallel transverse lines include a fluorescent colored pigment.

16. An apparatus for collecting and viewing microscopic constituents through a microscope as set forth in claim 11, wherein said transparent tape includes a label area for recording information.

17. An apparatus for conveying microscopic constituents from a testing surface to a microscope slide, the microscope slide having a bottom engaging surface and a top engaging surface, the microscopic constituents viewed through a microscope, comprising:
a transparent tape having a bottom receiving surface and a top receiving surface;
a collection area on said bottom receiving surface for impressing against the testing surface;
a locking area on said bottom receiving surface for impressing against the top engaging surface of the microscope slide;
an adhesive layer on said bottom receiving surface for affixing the constituents within said collection area and for affixing said locking area against the top engaging surface of the microscope slide;
a plurality of markers on said top receiving surface for dividing said top engaging surface into a plurality of areas;
said plurality of markers of said top receiving surface positioned above said collection area of said bottom receiving surface for simultaneously viewing said plurality of markers and said collection area through the microscope;
said collection area of said bottom receiving surface impressed against the testing surface for engaging said adhesive layer with the constituents for affixing the constituents within said collection area;
said locking area of said bottom receiving surface impressed against the top engaging surface of the microscope slide for engaging said adhesive layer with said top engaging surface for preserving and restraining movement of the constituents;
said transparent tape and the microscope slide placed under the microscope to identify and count the number of the constituents per each area occupied by each of said plurality of markers; and
said transparent tape including a label area for receiving a date, location and/or time of collection of the microscopic constituents from the testing surface.

18. An apparatus for conveying microscopic constituents from a testing surface to a microscope slide as set forth in claim 17, wherein said plurality of markers comprises a grid printed on said transparent tape.

19. An apparatus for conveying microscopic constituents from a testing surface to a microscope slide as set forth in claim 17, wherein said plurality of markers comprises a grid printed on said transparent tape; and
said grid includes a plurality of parallel lines and a plurality of parallel transverse lines for creating a plurality of areas with equivalent dimensions.

20. An apparatus for conveying microscopic constituents from a testing surface to a microscope slide as set forth in claim 17, wherein said plurality of markers comprises a grid printed on said transparent tape;
said grid includes a plurality of parallel lines and a plurality of parallel transverse lines for creating a plurality of areas with equivalent dimensions; and
said plurality of parallel lines and a plurality of parallel transverse lines include colored pigment.

21. An apparatus for conveying microscopic constituents from a testing surface to a microscope slide as set forth in claim 17, wherein said plurality of markers comprises a grid printed on said transparent tape;
said grid includes a plurality of parallel lines and a plurality of parallel transverse lines for creating a plurality of areas with equivalent dimensions; and
said plurality of parallel lines and a plurality of parallel transverse lines include a fluorescent colored pigment.

22. (canceled)

23. A process of collecting and viewing microscopic constituents through a microscope, comprising the steps of:
impressing an adhesive tape having a plurality of markers to a test surface for affixing the constituents to said adhesive tape;
impressing said adhesive tape to a microscope slide for preserving and restraining movement of the constituents; and
counting the number of the constituents per each area occupied by each of said plurality of markers.

24. A process of collecting and viewing microscopic constituents through a microscope, comprising the steps of:
impressing an adhesive tape having a plurality of markers to a test surface for affixing the constituents to said adhesive tape;
impressing said adhesive tape to a microscope slide for preserving and restraining movement of the constituents; and
placing said adhesive tape and said microscope slide under the microscope to identify and count the number of the constituents per each area occupied by each of said plurality of markers.

25. A process of collecting and viewing microscopic constituents as set forth in claim 24, wherein the step of counting the number of the constituents includes establishing the total number of constituents observed per the total area observed under the microscope.
